(19) United States
(12) Patent Application Publication
(10) Pub. No.: US 2016/0009381 A1
(43) Pub. Date: Jan. 14, 2016

(54) SYSTEM FOR FAST FIXING AN ACCESSORY TO A DRONE BODY

(71) Applicant: PARROT, Paris (FR)

(72) Inventors: Yoni Benatar, Les Lilas (FR); Karim Fargeau, Charenton Le Pont (FR)

(21) Appl. No.: 14/794,119

(22) Filed: Jul. 8, 2015

(30) Foreign Application Priority Data
Jul. 8, 2014 (FR) 1456589

(51) Int. Cl. B64C 25/34; B64C 39/02

(52) U.S. Cl. CPC B64C 25/34; B64C 39/024; B64C 2201/024

(57) ABSTRACT

The fast fixing system comprises a link part (24) integral with the accessory (22), and a support face (26) formed on the drone body (12). The link part is mobile in rotation (28) with respect to the frame between a free position allowing the placing or the removal of the accessory, and a locked position in which the link part is immobilized in rotation and in translation on the frame, so as to form with the latter an integral unit. Means are provided, which define the locked position by a rotation stop of the link part with respect to the frame, means for axial translation blocking of the link part with respect to the frame when the link part is in the locked position, and means for elastic fastening of the link part to the frame once the locked position reached.

### CROSS-REFERENCE TO RELATED APPLICATION

The present application claims priority of French application No. 14 56589 titled “System for fast fixing an accessory to a drone body,” filed on Jul. 8, 2014 with the Patent Office of the Republic of France, the disclosure of which is incorporated by reference in its entirety.

### TECHNICAL FIELD

The invention relates to drones, in particular rotary-wing drones such as quadricopters.

### BACKGROUND

Such drones comprise a drone body and a plurality of propulsion units mounted at the end of arms for connection to the drone body, each propulsion unit being provided with a propeller driven by a respective motor. The different motors can be controlled in a differentiated manner so as to pilot the drone in attitude and speed.

### SUMMARY

In certain configurations, it may be interesting to provide the drone with an accessory, removably mounted on the drone body.

In the following of the description, it will be described as an example of drone accessory a unit formed of a shaft provided at each of its ends with a wheel of great diameter. The shaft is oriented crosswise with respect to the main direction of evolution of the drone and the wheels have a diameter higher than the maximum overall size of the drone with its propellers. This configuration allows in particular not only to make the drone fly but also, provided with the wheels, to make this drone roll on the ground, along a wall, against a ceiling, etc., hence multiplying the possibilities of evolution, in addition to the usual configurations of free flight and lift of the drone.

However, this example must not in any way be considered as limitative because, as will be understood, the invention applies to the mounting of a very great number of accessories on the drone body.

It may hence be interesting to provide the drone with floats mounted at the end of the crosswise shaft, so as to allow the drone to land on a water area and to safely evolve on the latter.

They may also be accessories that do not use a support shaft, for example a removable auxiliary camera mounted on the drone back, etc.

In any case, it is desirable to be able to easily and rapidly mount and dismount this accessory, with no tool.

The fixing system must moreover allow a complete fastening between the accessory and the drone, these two elements having to form an integral unit when the accessory is locked onto the drone body.

In particular, in the case of a crosswise shaft fixed on the drone, it is important to prevent any axial translation of the shaft, which could cause a lateral displacement of the wheels with a risk for them to come into contact with the drone propellers.

The purpose of the invention is to propose a system for fast fixing an accessory to a drone body, which fulfils these requirements of easiness of use and reliability of the mechanical link between drone and accessory, in particular for an accessory mounted transverse to the drone through an element of tubular shape.

On the other hand, insofar as it is desired to use this fixing system with consumers drones, toys, etc., it is advisable to use a system that can be easily mass produced, for a very low cost, while fulfilling the above-mentioned criteria of simply and reliability.

The fast fixing system must also have a versatile character, i.e. it must be able to be used to fix indifferently a great variety of different accessories on a same drone, without requiring any adapter or other additional element according to whether the user wishes to mount this or that accessory on the drone.

Various systems for fast fixing a removable member to a drone are described for example in the WO 2014/059549 Al, US 2014/0061376 A1, EP 2 236 416 A2, WO 2008/121983 A1 or also U.S. Pat. No. 4,591,114 A, but none of them allows to fulfil the whole requirements exposed hereinabove.

To achieve the above-mentioned purposes, the invention proposes a unit comprising a drone and a drone accessory adapted to be removably secured to the drone body, this unit comprising, as disclosed in the above-mentioned WO 2014/059549 A1, a system for fast fixing the accessory to the drone body, comprising a link part integral with the accessory and a support frame formed on the drone body, this frame being adapted to cooperate with the link part to allow the mounting, the positioning and the holding in place of the accessory on the drone body.

The link part is mobile in rotation with respect to the frame between a free position, in which the link part may be freely placed on the frame or separated from the frame, and a locked position, in which the link part is locked in rotation and in translation on the frame, so as to form with the latter an integral unit. The link part comprises means for rotation stop of the link part with respect to the frame, defining the locked position, means for axial translation blocking of the link part with respect to the frame when the link part is in the locked position, and means for elastic fastening of the link part to the frame once the locked position reached.

Characteristically, the link part comprises a tubular element defining at least one journal adapted to cooperate with the counterpart bearing of the frame, this bearing being a semi-cylindrical bearing with an opening directed outward to allow the journal of the link part to be placed therein. The link part also comprises a lever extending perpendicular to the tubular element with the journal arranged near the lever, at the proximal end of the lever.

According to various advantageous subsidiary characteristics:

the rotation stop means comprise on the frame a protrusion formed near the bearing and having a face directed in a direction opposite to that of the openings in the bearings, and on the link part, a stop face coming into contact with and in rest against the face of the frame protrusion once the locked position reached;
the axial translation blocking means comprise on the link part at least one shoulder formed on the tubular body near the journals, and on the frame, stop faces continuing radially the semi-cylindrical bearing and coming in rest against the shoulder of the link part;
the means for elastic fastening of the link part to the frame once the locked position reached comprise a boss formed at the distal end of the lever and a cooperating recess formed in a counterpart area of the frame, or vice versa;
the lever is elastically deformable over its length so as to allow, by a pressure exerted crosswise with respect to this length, to move the boss away from the recess and to hence allow the separation between the link part and the frame and the consecutive rotation of the link part from the locked position to the free position;
the accessory comprises a shaft integral with the link part and extending axially with respect to the tubular body on either side of the latter, this shaft being in particular able to carry wheels at each of its ends.

An exemplary embodiment of the invention will now be described, with reference to the appended drawings in which the same references denote identical or functionally similar elements throughout the figures.

### BRIEF DESCRIPTION OF THE DRAWINGS

FIG. 1 is an overall, perspective view of a drone provided with an accessory consisted, in the example illustrated, by a pair of lateral wheels.

FIGS. 2a and 2b are enlarged views of the central part of the drone of FIG. 1, equipped with its accessory, showing the fast fixing system, in the initial accessory placing position and in the final locked position, respectively.

FIG. 3 shows in more details the constitutive elements of the fast fixing system, with the link part and the counterpart support frame formed on the drone body.

FIG. 4 is an isolated view of the link part, according to an angle different from that of FIG. 3.

FIGS. 5a and 5b are side views showing, in the initial position and in the final locked position, respectively, the link part and the cooperating support frame.

### DETAILED DESCRIPTIONS

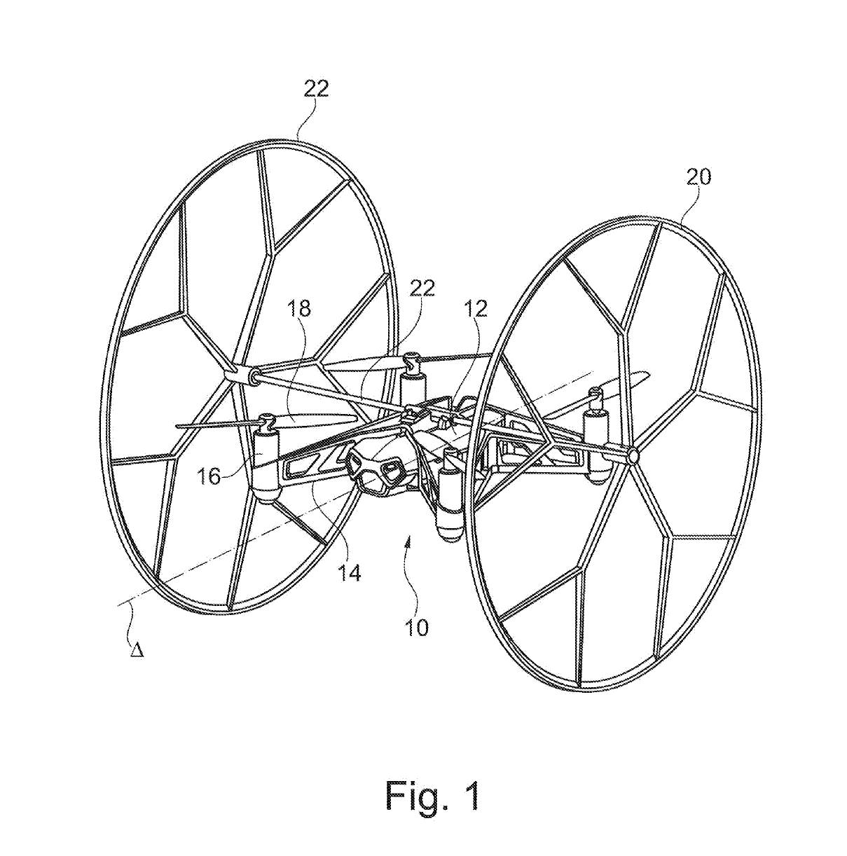

FIG. 1 shows a unit including a drone 10 of the quadricopter type, with a central body 12 from which radiate four support arms 14. Each support arm 14 is equipped at its distal end with a propulsion unit 16 comprising a motor driving into rotation a propeller 18 extending in a horizontal plane above the support arm 14.

The drone 10 is provided with an accessory formed of two lateral wheels 20 of great diameter (a diameter higher than the overall size of the drone with its propellers), extending in planes parallel to the main direction A of evolution of the drone, and arranged on either side of the drone body 12 and of the propulsion units 16 and of the propellers 18. The wheels 20 are carried by a cross shaft 22, which is mounted on the drone body 12 so as to be integral in translation and in rotation with the latter (i.e. the shaft 22 cannot move axially, nor rotate about itself). The wheels 20 are mounted freely in rotation at the end of the shaft 22, each of the two wheels being hence able to rotate independently of each other and being that way purely passive. The wheels 20 have no driving role, they only serve to allow the drone to stay remote from the ground or from a wall while staying in contact with the ground or the wall. The drone, moved by the only force of its propellers, can then roll on this ground or this wall.

The shaft 22 is advantageously mounted on the back of the drone, so that the centre of gravity of the latter is located under the shaft 22, and hence under the centre of rotation of the wheels 20, which will allow a natural coming back to balance, whatever the lift conditions.

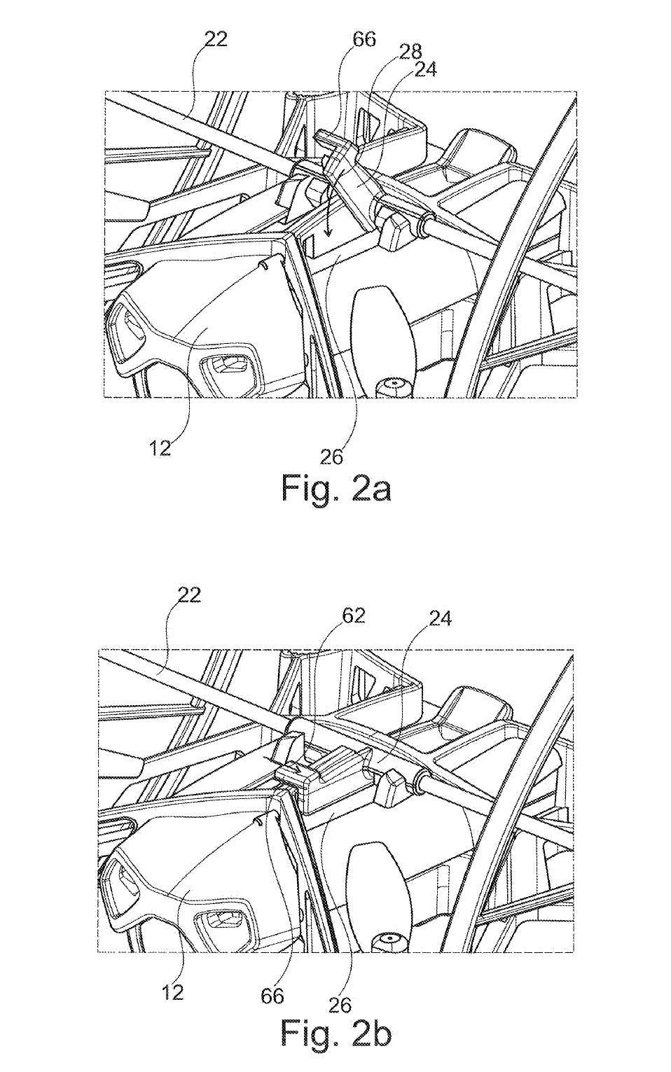

FIGS. 2a and 2b illustrate in more detail the way the shaft 22 is mounted on the drone body 12.

This mounting is made by means of a fast fixing system, characteristic of the invention, comprising a link part 24 removably cooperating with a frame 26 integral with the drone body 12. The link part 24 is integral in rotation and in translation with the shaft 22, and may be placed in the frame 26 (position illustrated in FIG. 2a). The link part 24 may be in particular moulded directly over the shaft 22 so that these two elements are made integral with each other both in rotation and in translation, with no relative degree of freedom.

The locking of the link part 24 on the frame 26, and hence the locking of the drone accessory (herein materialized by the shaft 22) on the drone body 12, is obtained by a rotation between:

an initial position, illustrated in FIG. 2a, where the link part 24 may be freely placed on the frame 26 (or dissociated from the latter), and
a locked position, illustrated in FIG. 2b, where the link part 24 is locked in rotation and in translation on the frame 26, so as to form with the latter an integral unit, without relative degree of freedom.

The switching from the initial position to the locked position is operated by a simple rotation over a fraction of a turn (about 60 to 90°), schematized by the arrow 28 in FIG. 2a. The mounting and the locking of the accessory on the drone body hence comes down to placing the link part 24 on the frame 26 and performing a rotation according to the arrow 28, without any other necessary handling.

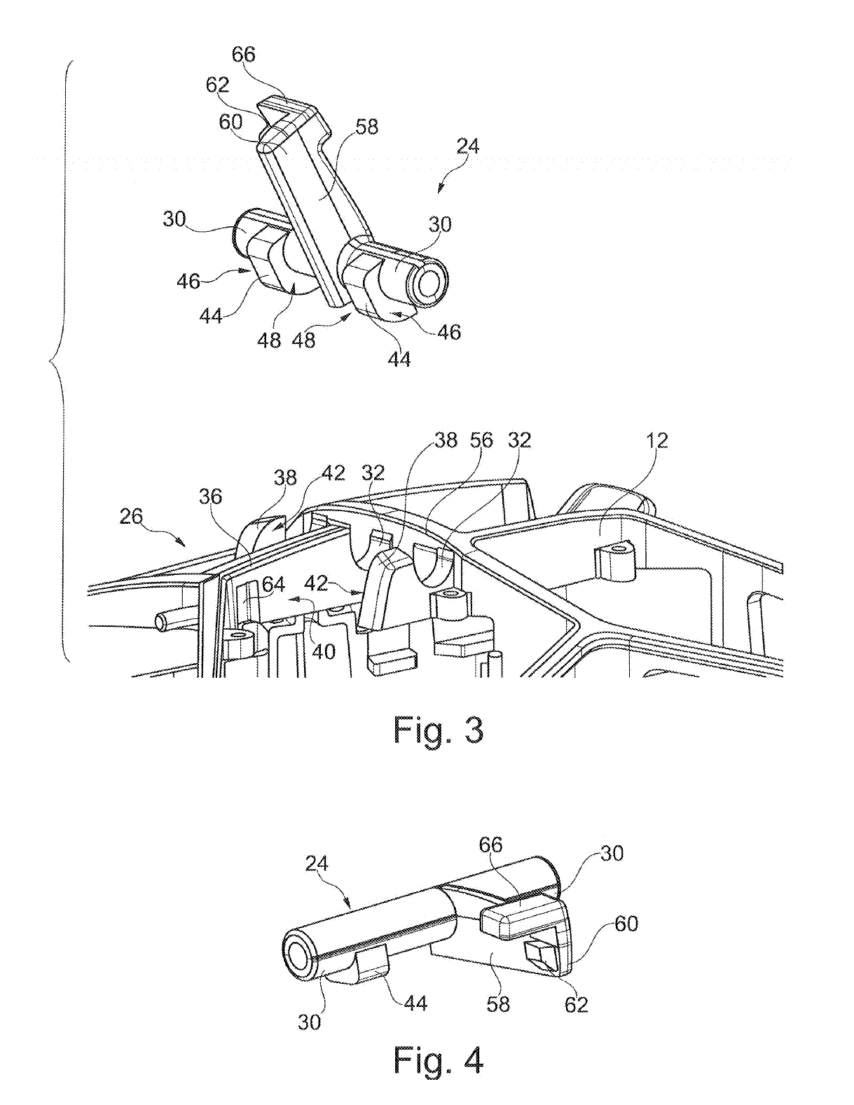

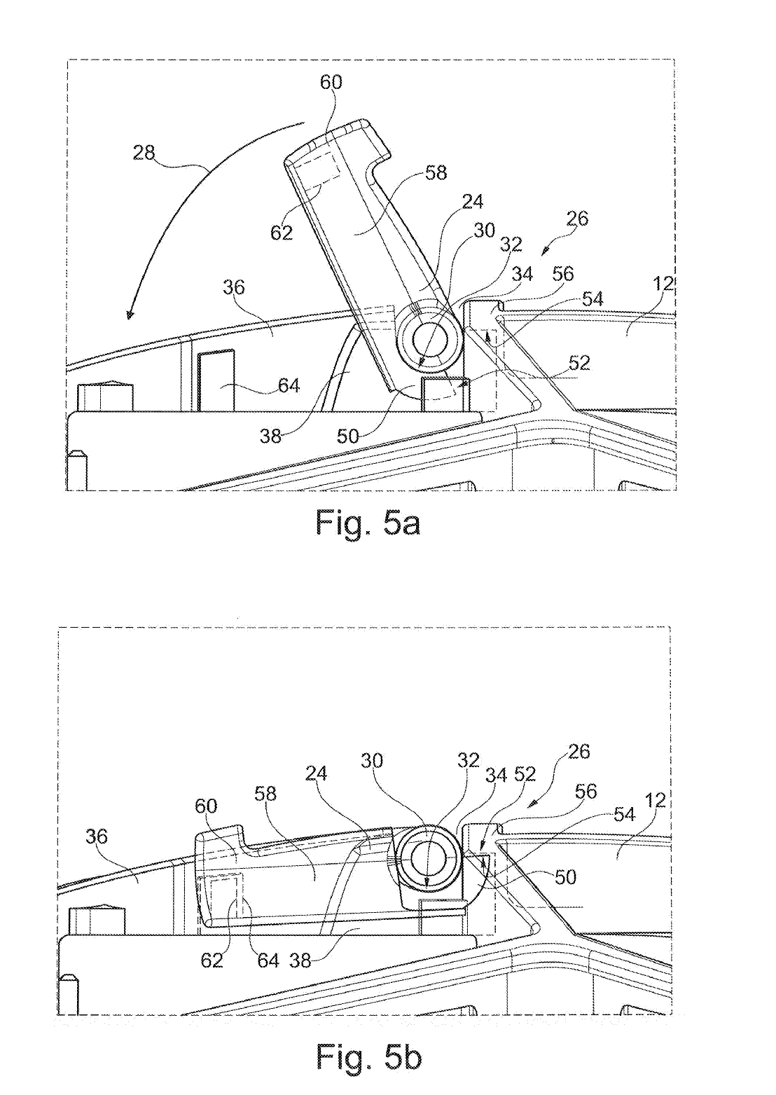

FIGS. 3 and 4, as well as FIGS. 5a and 5b, illustrate in more detail the constitutive elements of the link part 24 and of the support frame 26 allowing to reach the desired results.

The link part 24 comprises a tubular element coaxial with the shaft 22 (the shaft being not shown in FIGS. 3 and 4), defining two journals 30 intended to come in rest against counterpart bearings 32 of the support frame 26. These bearings 32 are upwardly open, the opening 34 (FIGS. 5a and 5b) being wide enough to allow the placing and the removal of the journals 30 of the link part 24 into and from the initial free position (position illustrated in FIGS. 2a, 3 and 5a). The support frame 26 also comprises a central rib 36 perpendicular to the axis of the journals 30 and two lateral ribs 38, the bearings 32 being formed in the ribs 38.

The central rib 36 and the lateral ribs 38 define two couples of planar faces 40, 42, parallel and opposite to each other, allowing to guide and receive a respective shoulder 44 formed on the tubular body of the link part 24. Each shoulder 44 includes stop faces 46, 48 coming into contact with the faces 42 of the lateral ribs 38 and 40, respectively, of the central rib 36. This configuration allows, once the link part 24 placed in the support frame 26, with the journals 30 in the bearings 32, to immobilize the link part 24, and hence the shaft 22, and generally the drone accessory, in axial translation with respect to the drone body 12.

The shoulders 44 further includes, as illustrated in FIGS. 5a and 5b, an end region 50 ending by a face 52 forming a stop face, for example a planar face extending in a radial plane. This stop face 52 is intended to come into contact against an opposite counterpart contact face 54 formed on a protruding edge 56 of the support frame 26. In the initial free position (FIG. 5a), the two faces 52 and 56 are spaced apart, and the rotation (arrow 28) toward the locked position places these faces in contact and in abutment with each other, preventing any exit of the journals 30 out of the bearings 32.

To hold the link part 24 in the locked position (i.e. the position of FIG. 5b), the link part 24 includes a lever 58 extending radially with respect to the tubular element carrying the journals 30. This lever 58 is provided at its end with a boss 62 intended to cooperate with a counterpart recess 64 formed in the central rib 36 of the support frame 26, the boss 62 being made on one of the lateral faces of the lever 58, near the distal end 60 thereof.

Due to the elasticity of the lever material, which is for example plastic material, the boss/recess unit 62, 64 constitutes elastic fastening (“clipping”) means resisting to the various external stresses, vibrations, etc., which could push the link part 24 in the opening direction in the absence of any operation by the user.

The link part 24/support frame 26 unit, and hence the drone body/accessory unit, hence remains perfectly secured once the lever 58 has been lowered until the boss 62 is “clipped” into the recess 64.

To dismount the accessory, the user just needs to exert a transverse action on the lever, for example via a nose 64 formed at the end 60, this operation being illustrated by the arrow 62 of FIG. 2b. This action, due to the lever elasticity, will have for effect to move the boss 62 away from the recess 64 and will hence unlock the lever 58 from the support frame 26, hence allowing a reverse rotation of the link part up to the free position where the accessory will be able to be easily removed.

1. A unit comprising:
a drone (10) with a drone body (12); and
a drone accessory (20, 22), adapted to be removably secured to the drone body,
wherein a system is provided for fast fixing the accessory to the drone body, this system comprising:
a link part (24) integral with the accessory; and
a support frame (26) formed on the drone body, this frame being adapted to cooperate with the link part to allow the mounting, the positioning and the holding in place of the accessory on the drone body,
the link part being mobile in rotation (28) with respect to the frame between:
a free position, in which the link part may be freely placed on the frame or separated from the frame, and
a locked position, in which the link part is locked in rotation and in translation on the frame, so as to form with the latter an integral unit,
and wherein the link part comprises:
means (52, 54) for rotation stop of the link part with respect to the frame, defining the locked position;
means (40, 42, 44) for axial translation blocking of the link part with respect to the frame when the link part is in the locked position; and
means (62, 64) for elastic fastening of the link part to the frame once the locked position reached,
characterized in that the link part further comprises:
a tubular element defining at least one journal (30) adapted to cooperate with a counterpart bearing (32) of the frame, this bearing being a semi-cylindrical bearing with an opening (34) directed outward to allow the journal of the link part to be placed therein;
a lever (58) extending perpendicular to the tubular element, with the at least one journal arranged near the lever, at the proximal end of the lever.

2. The unit of claim 1, wherein the rotation stop means comprise:
on the frame, a protrusion (56) formed near the bearing and having a face (54) directed in a direction opposite to that of the openings (34) in the bearings, and
on the link part, a stop face (52) coming into contact with and in rest against the face of the frame protrusion once the locked position reached.

3. The unit of claim 1, wherein the axial translation blocking means comprise:
on the link part, at least one shoulder (44) formed on the tubular body near the journals, and
on the frame, stop faces (40, 42) radially continuing the semi-cylindrical bearing and coming in rest against the shoulder of the link part.

4. The unit of claim 1, wherein the means for elastic fastening of the link part to the frame once the locked position reached comprise a boss (62) formed at the distal end (60) of the lever and a cooperating recess (64) formed in a counterpart area (36) of the frame, or vice versa.

5. The unit of claim 4, wherein the lever (58) is elastically deformable over its length so as to allow, by a pressure (62) exerted crosswise with respect to this length, to move the boss (62) away from the recess (64) and to hence allow:
the separation between the link part and the frame, and
the consecutive rotation of the link part from the locked position to the free position.

6. The unit of claim 1, wherein the accessory comprises a shaft (22) integral with the link part (24) and extending axially with respect to the tubular body on either side of the latter.

7. The unit of claim 6, wherein the shaft (22) carries wheels (20) at each of its ends
